(19) United States
(12) Patent Application Publication
(10) Pub. No.: US 2026/0176797 A1
(43) Pub. Date: Jun. 25, 2026

(54) FIBROUS CARBON MATERIAL FORMATION FROM HYDROCARBONS USING METAL CATALYSTS

(71) Applicant: THE UNIVERSITY OF BRITISH COLUMBIA, Vancouver (CA)

(72) Inventors: David Chester UPHAM, Vancouver (CA); Genpei CAI, Vancouver (CA); Karsten FEIGL, Vancouver (CA); Natascha MIEDERHOFF, Vancouver (CA); Stephan POPP, Vancouver (CA); Sawyer D’ENTREMONT, Vancouver (CA)

(21) Appl. No.: 19/426,406

(22) Filed: Dec. 19, 2025

Related U.S. Application Data
(60) Provisional application No. 63/736,892, filed on Dec. 20, 2024.

(51) Int. Cl. D01F 9/133; C01B 32/162

(52) U.S. Cl. CPC D01F 9/133; C01B 32/162; C01B 2202/06; C01P 2002/88; C01P 2004/03; C01P 2004/04

(57) ABSTRACT

Methods of pyrolyzing hydrocarbon are disclosed. The method is performed in the presence of a metal catalyst to produce a solid carbon product and hydrogen gas. A metal catalyst may be selected to preferentially produce carbon fibers and/or carbon nanotubes over other carbon products. In some embodiments, the metal catalyst comprises a metal catalyst containing indium (In).

### CROSS-REFERENCE TO RELATED APPLICATIONS

This application claims the benefit under 35 U.S.C. § 119 of U.S. application No. 63/736,892 filed 20 Dec. 2024 and entitled CARBON FIBER FORMATION FROM HYDROCARBONS USING METAL CATALYSTS which is hereby incorporated herein by reference for all purposes.

### FIELD

This invention relates to methods of pyrolyzing hydrocarbon, and in particular methods for making solid carbon products and hydrogen gas.

### BACKGROUND

Approximately 96% of hydrogen produced globally is generated from fossil fuels by methane steam reforming, oil/naphtha reforming, and coal gasification. These methods of hydrogen generation produce considerable greenhouse gas emissions and contribute to climate change. Methane pyrolysis is a method of CO₂-neutral hydrogen production where methane is decomposed into hydrogen and solid carbon. In the absence of a catalyst, this reaction occurs at temperatures between 1100-1200° C.

Catalysts that have been investigated for methane pyrolysis include solid catalysts that are either metal- or carbon-based, molten metal catalysts, and molten salt catalysts. Solid catalysts are prone to the formation of coke deposits that deactivate the active reaction sites and require periodic decoking. Molten catalysts are a new area of research for methane pyrolysis as they overcome the challenges of solid catalysts.

The reactor designed for reactions involving molten catalysts is often a liquid bubble column reactor. In a liquid bubble column reactor, every individual bubble functions as a miniature reactor. The interface where a gaseous hydrocarbon bubble meets a molten catalyst promotes the breakdown of the hydrocarbon. For example, when the hydrocarbon is methane, the resulting products are solid carbon and hydrogen. Carbon that is produced at the gas-liquid interface can follow one of several paths: it may remain at the gas-liquid interface of the bubble, ascend alongside the bubble, and accumulate on the liquid's surface, or the carbon may dissolve into the molten medium until reaching a saturation point, after which it precipitates out. If the density of the product is lower than that of the molten media the product remains deposited at the surface of the liquid column where it can be removed. In this way, the catalyst is continuously renewed and incoming reactants can be continuously contacted with fresh catalyst. This concept can also be applied to horizontal bubble column reactors which optimize gas throughput by allowing for a greater vessel length than is economically feasible with vertical columns. Other reactor set ups involving molten catalysts include surface reactors and horizontal boat reactors. An optimized reactor design for molten catalysts is still under investigation.

The present disclosure pertains to a process for hydrogen production that aims to bridge the existing gap between conventional fossil fuel-based production techniques and the envisioned “green” hydrogen generation achieved through water electrolysis. “Green” hydrogen generated via water electrolysis offers a clean and environmentally friendly alternative. However, this method requires a significant amount of energy, hindering its widespread adoption. An alternative avenue, so called “turquoise” hydrogen production, involves methane pyrolysis, which yields hydrogen and solid carbon as byproducts. Considering the substantial scale at which hydrogen production is targeted, it becomes evident that conventional methods may yield an excess of low-value carbon. The surplus carbon could potentially exceed the feasible demand for such carbon-based materials, thereby presenting a challenge for their effective utilization. In view of the foregoing challenges, there exists a need for a hydrogen production process capable of producing high-value byproducts using a method that is time- and cost-efficient.

### SUMMARY

This invention pertains to methods of pyrolyzing hydrocarbons for producing fibrous carbon materials. As used herein, “fibrous carbon materials” include carbon nanotubes (CNTs), carbon nanofibers, carbon fibers, and other fibrous carbon materials. In some embodiments, the fibrous carbon materials comprise carbon fibers. In some embodiments, the fibrous carbon materials comprise high-value forms of carbons such as carbon nanotubes (CNTs). The carbon nanotubes may comprise multi-walled carbon nanotubes (MWCNT). In some example embodiments, the pyrolysis reactions of such methods are catalyzed by a catalyst which preferentially produces carbon fibers over other fibrous carbon materials. In some example embodiments, the pyrolysis reactions of such methods are catalyzed by a catalyst which preferentially produces multi-walled carbon nanotubes over other fibrous carbon materials. In some embodiments, the catalyst comprises a metal catalyst containing indium (In).

In some embodiments, the method of producing fibrous carbon materials comprises contacting a gaseous hydrocarbon feed with a metal catalyst containing indium within a vessel to produce a plurality of fibrous carbon materials on a surface of the metal catalyst.

In some embodiments, the method of producing fibrous carbon materials comprises contacting a gaseous hydrocarbon feed with a metal catalyst containing indium within a vessel for a first time interval to produce a first carbon product on a surface of the metal catalyst. In some embodiments, the first carbon product comprises an amorphous carbon. The hydrocarbon feed may be caused to continuously contact with the metal catalyst for a second time interval to produce a plurality of molten metal droplets on a surface of the first carbon product. The hydrocarbon feed may be caused to further continuously contact the hydrocarbon feed with the metal catalyst for a third time interval to produce a plurality of fibrous carbon materials from the plurality of molten metal droplets.

In some embodiments, the producing of the plurality of fibrous carbon materials from the plurality of molten metal droplets comprises producing one of the plurality of carbon fiber from the respective one of the plurality of molten metal droplets.

In some embodiments, the producing of fibrous carbon materials from the plurality of molten metal droplets comprises producing one of the plurality of carbon fibers with a diameter substantially equal to or greater than a diameter of the respective one of the plurality of molten metal droplets.

In some embodiments, one or more of the fibrous carbon materials comprise a tubular structure. In some embodiments, one or more of the fibrous carbon materials have one or more layers of ordered carbon atom. The one or more layers of ordered carbon atoms may be arranged concentrically around a cylindrical axis of the fibrous carbon materials, such as carbon fibers.

In some embodiments, at least some of the solid carbon products formed from the fibrous carbon material production method of the present invention comprise an ordered carbon structure. In some embodiments, a majority of the solid carbon products formed adopt an ordered carbon structure. In some embodiments, carbon fibers form the majority of the solid carbon products produced from the carbon fiber production method.

“Ordered carbon” may refer to a structure in which the carbon atoms are arranged in a consistently systematic manner. “Disordered carbon” may refer to a structure in which the carbon atoms are arranged along different directions, and the aligning directions of the carbon atoms may be random.

As used herein, “majority” refers to greater than about 50%, and in some embodiments greater than about 60%, and in some embodiments, greater than about 70%, and in some embodiments, greater than about 80%, and in some embodiments, greater than 90%.

In some embodiments, the plurality of fibrous carbon materials such as carbon fibers formed from the described method have an average diameter less than an average length thereof. In some embodiments, the plurality of fibrous carbon materials such as carbon fibers have an average length in the range of from about 10 μm to about 1 cm. In some embodiments, the plurality of fibrous carbon materials such as carbon fibers have an average diameter in the range of from about 10 nm to about 500 nm.

In some embodiments, the metal catalyst containing indium selected for use to preferentially produce fibrous carbon materials such as carbon fibers has low or limited solubility to carbon.

In some embodiments, the metal catalyst containing indium consists essentially of indium. In some embodiments, the metal catalyst containing indium comprises an alloy comprising indium and one or more second metals. The one or more second metals may comprise one or more transition metals. In some embodiments, the one or more second metals are selected from the group consisting of copper (Cu), zinc (Zn), gold (Au), tin (Sn), platinum (Pt), palladium (Pd), nickel (Ni), iron (Fe), manganese (Mn), molybdenum (Mo), and bismuth (Bi).

In some embodiments, a ratio of indium and the one or more second metals of the metal catalyst is in the range of from 100:0 to 10:90, and in some embodiments, one of 100:0, 60:40, 50:50, 40:60, 20:80, and 10:90.

In some example embodiments, the metal catalyst comprises an indium-copper alloy. In some embodiments, the ratio of indium to copper in the metal catalyst is about 40:60.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a schematic of the proposed mechanism of carbon fiber production according to an example embodiment of the invention.

FIG. 2 is a schematic of the general method by which hydrocarbons are contacted with a catalyst to produce carbon fibers.

FIG. 3 is a schematic representation of a bubble column reactor.

FIG. 4 is a SEM image of the carbon fibers formed during methane pyrolysis using a 40:60 indium:copper catalyst.

FIG. 5 is a SEM image of the carbon fibers formed during methane pyrolysis in a surface reactor. The temperature was 980° C. gas contacted the melt for 270 min, and the indium:copper ratio was 40:60.

FIG. 6 is a SEM image of a single fiber from the batch of fibers depicted in FIG. 5.

FIG. 7 is a SEM image of the carbon fibers from a bubble column reactor. The temperature was 980° C. and the indium:copper ratio was 40:60.

FIG. 8 is a SEM image of the carbon fibers from FIG. 7 after 10 hours heat treatment at 1090° C.

FIG. 9 is a schematic of a horizontal boat reactor.

FIG. 10 is a is a schematic of a proposed mechanism of carbon fiber production according to another example embodiment of the invention.

FIG. 11 is SEM images of a catalyst surface (a) before and (b) after purification treatment. The fibers were treated under a hydrogen-argon atmosphere (ratio 1:20) for 24 hours at 1096° C. The catalyst was indium:copper ratio with a ratio of 40:60.

FIG. 12 is SEM images of carbon structures on different alloy surfaces after running methane pyrolysis in a surface reactor for 40 min: a) 50:50 mol. % Ge:In. b) 50:50 mol. % Sn:In. c) 50:50 mol. % Ag:In. d) 50:50 mol. % Ge:Cu. e) 50:50 mol. % Bi:Cu.

FIG. 13 is SEM images of carbon on various catalyst surfaces after methane pyrolysis in a surface reactor: a) and b) show pure liquid In; c) and d) show liquid 60:40 mol. % Cu—In; e) and f) show pure solid Cu. The catalysts were tested after cooling to the room temperature.

FIG. 14 is SEM images of carbon structures on different Cu:In catalyst compositions: a) and b) 20:80 mol. % Cu:In. c) and d) 40:60 mol. % Cu:In. e) and f) 80:20 mol. % Cu:In.

FIG. 15 is SEM and TEM images of generated carbon on catalyst surface. a) and b) show fibers produced in a bubble column reactor before purification. c) displays an image of the Cu—In catalyst after cooling from a bubble column experiment, with carbon visible only on the surface of the catalyst. d) illustrates catalyst performance over 24 hours in a bubble column reactor. e) TEM image displaying bamboo-like structures after purification. f-g) TEM and SEM images illustrating smooth tubular structures after purification.

FIG. 16 is SEM and EDX analyses of CNFs growth and composition. a) SEM images of the catalyst surface showing carbon deposition after reaction times of carbon: i) 2 minutes, ii) 3 minutes, iii) 270 minutes. b) Illustration of the proposed pathway for CNF growth. c) EDX result showing the composition of metal droplets attached to fiber tips, containing In and Cu.

FIG. 17 are SEM images of carbon fiber attached to a droplet: a) droplet size larger than fiber diameter b) droplet size like fiber diameter.

FIG. 18 are SEM images of carbon on catalyst after 40 min reaction time: (a) with CO2 and (b) without CO2.

FIG. 19 are SEM images of post-pyrolysis catalysts after a reaction time of 2 hours for a) Cu₀In₁₀₀, b) Cu₂₀In₈₀, c) Cu₅₀In₅₀, d) Cu₇₀In₃₀, e) Cu₈₀In₂₀, f) Cu₁₀₀In₀.

FIG. 20A is a plot showing cumulative droplet diameter distribution of pre-reaction catalyst droplets for the post-reaction catalysts shown in FIG. 19.

FIG. 20B is a plot showing distribution of MWCNT diameters from loading series and frozen catalyst droplet diameters from reduced 0.75 mol/m² (7.5 wt. %) catalysts. Distribution curves are added as a visual assist to the datasets.

FIG. 21 are TEM Images of the MWCNT internal structures from the packed bed reactor. FIG. 21 shows a) tube-like, smooth MWCNT b) bamboo-like, sectional MWCNT, c) overview of MWCNT types, d) graphene MWCNT tube layer spacing, and e) Raman spectroscopy of one MWCNT sample D and G peaks with mean I_{D}/I_{G} ratio and 95% confidence interval from six scans. Samples shown are from a 0.75 mol/m² (7.5 wt. %) Cu₆₀In₄₀ catalyst.

FIG. 22 a) is a 2 kV SEM image showing the external structure of the MWCNT and catalyst head, b) is a 10 kV SEM image showing internal bamboo-like structure and catalyst head and tail structure, c) is a EDX scan on catalyst droplet which indicates Cu—In alloy. Sample is from a 0.75 mol/m² (7.5 wt. %) Cu₈₀In₄₀ catalyst.

FIG. 23 shows results of TEM image analysis of bamboo-like MWCNT sections, a) shows a series of 9 sections is analyzed, b) a plot showing that the equations are fit to the curvature of the void, pointing to section number 8 s as an example, c) is a plot of volume as a function of section number, showing that the volume of the solid of revolution is calculated, yielding the void volume.

FIG. 24 are images showing a shorter reaction time: a) for a reduced pre-reaction catalyst, b) a catalyst after 30 seconds exposure to CH₄ at 1000° C., c) after 3 minutes total exposure to CH₄, and which the arrow highlights the thick carbon structures, d) after 15 minutes total exposure. After the specified short reaction times, 15 SCCM Ar was used to purge the reactor. Images showing a longer reaction time: e) 30 minutes, f) 1 hour, g) 1.5 hours, and h) 2 hours following normal procedure.

FIG. 25 is a) a SEM Image of pre-reaction Cu₆₀In₄₀ catalyst supported on carbon coated SiO₂ with alloy particle measurement via EDX, b) show overlapping EDX scans of copper and indium, c) an indium EDX map, d) a copper EDX map.

FIG. 26 is a plot of heat flow per gram sample from DTA comparing reference alloy melting peaks to the residual metal remaining in MWCNT sample generated using a Cu₆₀In₄₀ catalyst, matching the Cu₆₀In₄₀ reference. The insert shows a comparison of DTA temperatures of maximum heat flow to liquidus line from phase diagram, crosses represent experimental melting point data.

FIG. 27 shows the effect of catalyst loading on synthesized MWCNTs. a) 0.1875 mol/m² (2.0 wt. %), b) 0.375 mol/m² (3.9 wt. %), c) 0.75 mol/m² (7.5 wt. %), d) 1.125 mol/m² (10.9 wt. %), e) 1.5 mol/m² (14.0 wt. %), f) 2.25 mol/m² (19.6 wt. %), g) 3 mol/m² (24.6 wt. %), h) 5.625 mol/m² (37.9 wt. %).

FIG. 28 are SEM images showing results from using a carbon pellet supported Cu—In catalyst a) shows a MWCNT dense section of catalyst, b) is a close-up of MWCNTs with catalyst droplets on tip, c) shows MWCNTs growing inside of pores of carbon support.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### EXAMPLE EMBODIMENTS

Aspects of the invention pertain to methods of pyrolyzing hydrocarbon to produce fibrous carbon materials. A catalyst may be used to enable this conversion. Some aspects of the invention pertain to a composition of the catalyst used in the pyrolysis of the hydrocarbon to selectively produce carbon fibers. Some aspects of the invention pertain to a composition of the catalyst used in the pyrolysis of the hydrocarbon to selectively produce carbon nanotubes such as multi-walled carbon nanotubes. In some embodiments, the catalyst comprises an indium-containing metal catalyst. The inventors discovered that an indium-containing metal catalyst allows for carbon fibers and/or carbon nanotubes to be preferentially produced over other fibrous carbon materials. In some embodiments, the hydrocarbon is methane. The hydrocarbon may have the general chemical formula CₙH₂ₙ₊₂.

As used herein, the term “pyrolysis” refers to the thermal decomposition of a material in the absence of oxygen. In some embodiments of the present invention, the method involves the pyrolysis of hydrocarbons (e.g., methane) to preferentially produce carbon fibers and/or carbon nanotubes. The term “preferentially” is meant to convey that the majority of solid carbon products that are generated from the pyrolysis reaction of the present method is carbon fibers and/or carbon nanotubes, as opposed to amorphous carbon, carbon black, or other carbon allotropes.

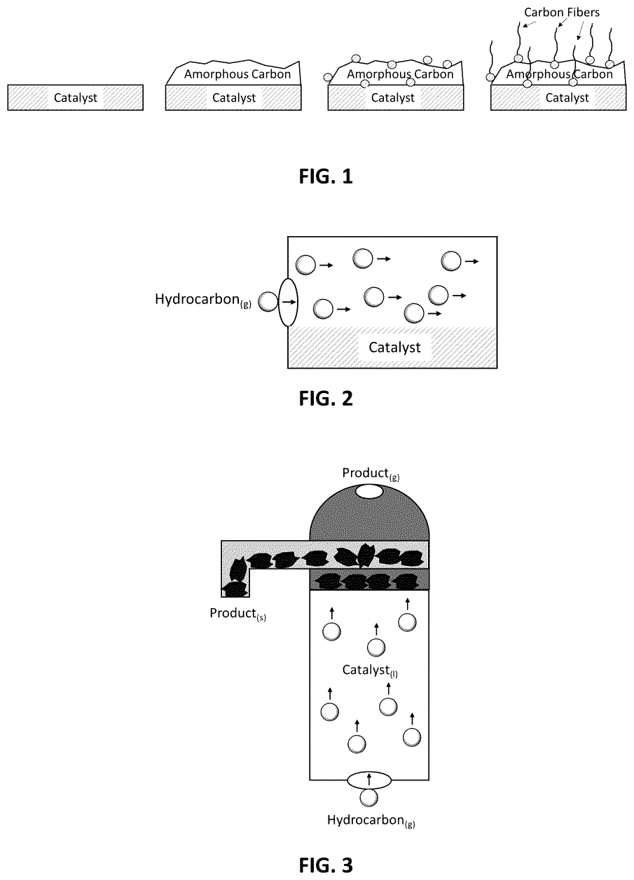

FIG. 1 illustrates schematically a proposed mechanism by which fibrous carbon materials are formed in the methods of the present invention, in accordance with an example embodiment. The method may comprise contacting a gaseous hydrocarbon feed with a metal catalyst containing indium within a vessel to produce a first carbon product on a melt surface of the metal catalyst. The vessel may be an open or closed vessel. The first carbon product may be an amorphous carbon. Continuous contacting of the hydrocarbon feed with the metal catalyst may cause droplets of the metal catalyst to migrate to the surface of the first carbon product. The droplets may serve to catalyze the growth of fibrous carbon materials such as carbon fibers from the surface of the first carbon product.

In some embodiments, the hydrocarbon feed comprises methane. In such embodiments, methane is caused to react with an indium-containing metal catalyst in a reactor to produce fibrous carbon materials (e.g., carbon fibers) and hydrogen. In some example embodiments, methane and CO₂ are reacted with an indium-containing metal catalyst in a reactor to produce fibrous carbon materials (e.g., carbon fibers), hydrogen, and carbon monoxide.

The methods described here involve using an indium-containing metal catalyst. In some embodiments, the indium-containing metal catalyst is entirely composed of indium. In some embodiments, the indium-containing metal catalyst comprises indium and a second metal. The second metal may comprise one or more metals. The catalyst composition may comprise different ratios of indium to the second metal, including but not limited to 100:0, 60:40, 50:50, 40:60, 20:80, and 10:90, respectively.

In some embodiments, the indium-containing metal catalyst is structured as an alloy. In such embodiments, the indium-containing metal catalyst is synthesized by combining indium and a second metal. In some embodiments, the second metal comprises one or more transition metals. In some embodiments, the second metal comprises one or more of copper (Cu), zinc (Zn), gold (Au), tin (Sn), platinum (Pt), palladium (Pd), nickel (Ni), iron (Fe), manganese (Mn), molybdenum (Mo), and bismuth (Bi).

In some example embodiments, the indium-containing metal catalyst comprises an indium-copper, indium-zinc, or indium-gold alloy. In some example embodiments, the indium-containing metal catalyst comprises an indium:copper alloy. In some example embodiments, the ratio of indium to copper is 40:60.

In some embodiments, the indium-containing metal catalyst is synthesized by heating a metal in a reducing atmosphere to a reaction temperature. For example, a bimetallic alloy may be synthesized by mixing the preferred ratio of solid metals together, loading them into a synthesis vessel or reactor, exposing them to a hydrogen atmosphere, and heating them to a temperature at which they form a homogeneous melt. After the melt is formed, the temperature of the molten catalyst alloy may be adjusted to the reaction temperature and the hydrogen atmosphere may be changed.

In some embodiments, the vessel is heated to a temperature at which a reaction is predicted to proceed at between 80° and 1200° C., and in some embodiments, between 90° and 1000° C., and in some embodiments, at about 980° C. Indium has a melting point of 157° C. and this melting point may be increased or decreased depending on the metal used in the alloy and the ratio of the metal used. Thus, depending on the indium-metal alloy chosen, the catalyst may either be in a solid or liquid/molten state when it is used to catalyze the pyrolysis of methane.

In some embodiments, contacting a gaseous hydrocarbon with a catalyst in a vessel involves flowing the hydrocarbon over the surface of the catalyst, as illustrated in FIG. 2. For example, flowing methane over an indium-containing metal catalyst. Experimental work has shown that higher conversion of methane to hydrogen and fibrous carbon materials (e.g., carbon fibers) may be achieved by increasing the length of time that methane flows over the indium-containing metal catalyst. In some embodiments, the total time that gaseous hydrocarbon (e.g., methane) is caused to contact or flow over the indium-containing metal catalyst is between 0 hours and 1,000 hours, and in some embodiments, between 0 hours and 100, and in some embodiments, about 3 hours.

In some embodiments, the method of generating fibrous carbon materials (e.g., carbon fibers) from hydrocarbon (e.g., methane) pyrolysis involves packing a bubble column reactor with a catalyst and bubbling hydrocarbons through the catalyst, as illustrated in FIG. 3. In one example, the catalyst is an indium-copper alloy at a ratio of 40:60, respectively, however it will be understood that any indium-containing metal catalyst or a pure indium catalyst may alternatively be used. Gaseous hydrocarbon (e.g., methane) may be caused to bubble through the catalyst. The temperature maintained within the reactor may in some embodiments be at around 980° C., or at any other suitable temperature so as to cause the indium-containing metal catalyst to be in a liquid or molten state. The products of the reaction are fibrous carbon materials (e.g., carbon fibers) and hydrogen. In some embodiments, carbon fibers are the majority carbon form produced. The hydrogen that is produced continuously may be caused to flow out of the reactor above the melt. In this process, the solid fibrous carbon materials (e.g., carbon fibers) may float to the surface of the bubble column where they are continuously removed. The fibrous carbon materials (e.g., fibers) may be physically scraped from the surface of the bubble column. The fibrous carbon materials (e.g., fibers) may be entrained in a gas stream for discharge out of the reactor, and/or drawn off with liquid metal and filtered from the melt. In some embodiments, the fibrous carbon materials (e.g., fibers) are entrained in a gas stream for discharge out of the reactor and then separated from the gas in another unit operation, e.g., a unit operation downstream of the reactor.

In some embodiments, methane pyrolysis (Eq 1) is combined with dry reforming (Eq 2) in a molten metal bubble column. The resulting products may be 2:1 hydrogen (H₂) and carbon monoxide (CO), also known as syngas that may be suitable for liquid fuel production, and solid fibrous carbon materials (e.g., fibers) (Eq 3). In some embodiments, methane and carbon dioxide (CO₂) are co-fed to a reactor containing a catalyst. In one example, the catalyst is an indium-copper alloy, at a ratio of 40:60, respectively, however, any indium-containing metal catalyst or a pure indium catalyst at any suitable indium:second metal ratio may be used. The methane pyrolysis and dry reforming reactions may occur simultaneously. The combined reactions may produce solid fibrous carbon materials (e.g., fibers) that may be caused to float to the surface of the molten media in the bubble column and may therefrom be continuously removed. The combined reactions may also produce syngas. The syngas may be removed via one or more outlets arranged at the top of the reactor where the syngas may be collected and optionally processed for further use. The fibrous carbon materials (e.g., fiber) formation in the presence and absence of CO₂ illustrates that the presence of CO₂ may not enable or impact the formation of the fibrous carbon materials (e.g., fibers).

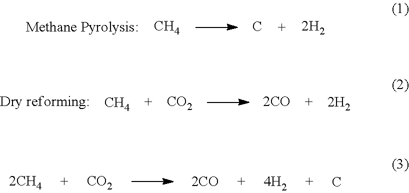

Molten metal bubble columns may be effective reactors for catalysis involving molten metals because they have high rates of heat transfer, which avoid hot or cold spots, and allow for affordable use of electric heating, and they allow for precise control of the flow rate and therefore the residence time of the product being contacted with the catalyst. In one example embodiment, quartz bubble columns may be used for pyrolysis reactions involving molten metal catalysts. Such quartz bubble columns may for example be operated for 30 hours.

In another embodiment, a surface reactor may be used whereby reactant gases are caused to flow over the surface of a catalytic melt and fibrous carbon materials (e.g., fibers) are produced on surface of the catalyst. The gaseous products may exit the reactor and the fibrous carbon materials (e.g., fibers) may accumulate. After appreciable amounts of fibrous carbon materials (e.g., fibers) have accumulated, the fibrous carbon materials may be physically removed from the surface and/or blown off from the surface of the catalyst with a high flow rate of gas.

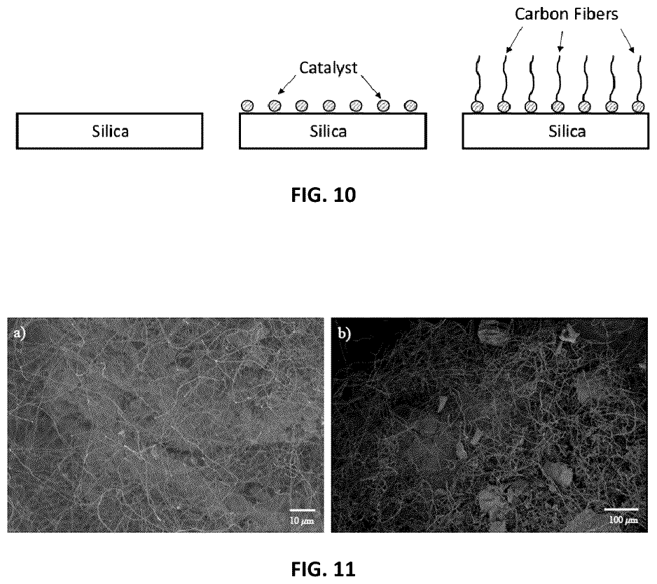

Referring to FIG. 9, in some embodiments, the vessel is a horizontal boat reactor. Referring to FIG. 10, in some embodiments, fibrous carbon materials (e.g., fibers) are produced by depositing metal catalyst droplets on an inert material in a vessel. The metal catalyst droplets may be deposited on the inert material by a catalyst droplet formation method. A suitable catalyst droplet formation method may for example comprise wet chemical methods (e.g., precipitation or wet impregnation) and deposition methods (e.g., evaporation deposition). In some embodiments, the inert materials on which the metal catalyst droplets may be deposited comprise silica and/or quartz. Following catalyst droplet deposition, the vessel may be maintained at a temperature of around 980° C., or at any other suitable temperature so as to cause the metal catalyst to be in a liquid or molten state. A gaseous hydrocarbon feed may be supplied into the vessel to contact the molten metal droplets for a set time interval. Fibrous carbon materials such as a plurality of carbon fibers may be produced from the plurality of molten metal droplets.

In some embodiments, the CO₂ reactant in the combined methane pyrolysis and dry reforming reaction is sourced from a waste stream. Examples of CO₂ waste streams may include biogenic CO₂ sourced from an anaerobic digester using agricultural and municipal organic waste or biogenic CO₂ from a lime kiln in a pulp mill. However, any suitable CO₂ waste stream may be used.

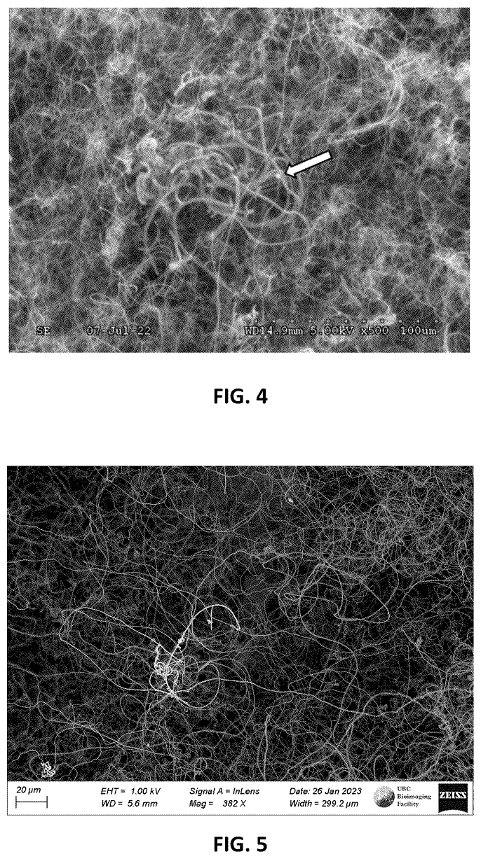

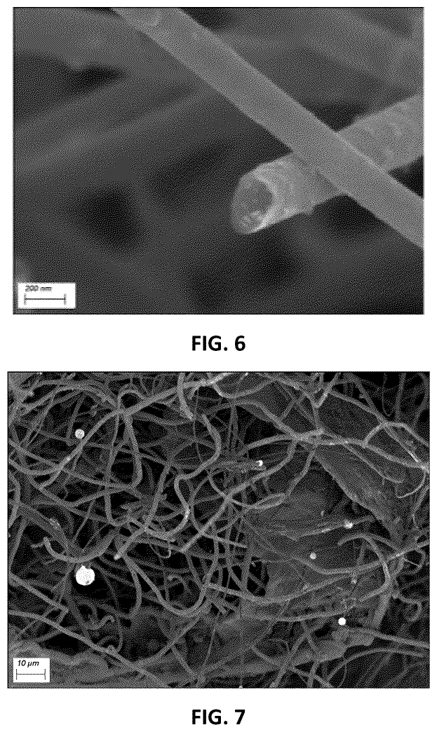

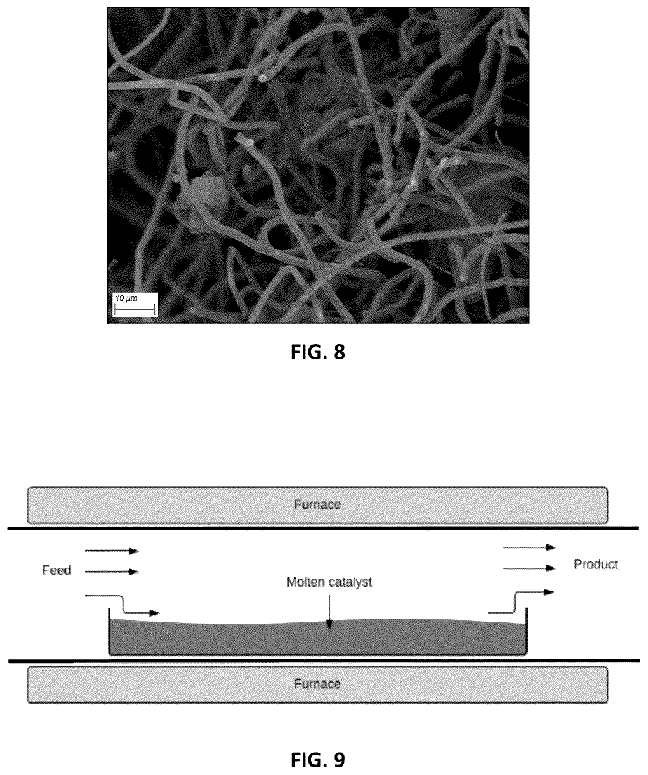

FIGS. 4-8 and FIGS. 11-18 are experimental results from performing a method of producing fibrous carbon materials in particular carbon fibers in accordance with an example embodiment of the invention as explained in the Examples below. In some embodiments, the produced fibrous carbon materials are carbon fibers that are bundled. In some embodiments, such carbon fibers have an average length of from about 10 microns to about 1 mm. The carbon fibers may contain the metal catalyst when the fibers are floating on the surface of the catalytic melt, as illustrated in FIG. 4. Referring to FIG. 4 and FIG. 6, the fibers may vary in thickness. In some embodiments, the carbon fibers have an average thickness of from about 10 nm to about 10 microns. In some embodiments, at least some of the carbon fibers are hollow. Referring to FIG. 5, larger fibers are presented in the middle of the SEM image in the front area whereas smaller fibers are visible behind them. In some embodiments, the size of the linked droplet varies from about 1 to about 5 micrometer. When the metal catalyst is removed post-reaction from the carbon fibers via evaporation, less than 1% of the metal catalyst may remain in the fibers, as illustrated in FIG. 7 and FIG. 8 where EDX analysis resulted in fibers taken from the surface of the bubble column in FIG. 7 had 1.26% metal catalyst. After thermally heating the fibers to 1090° C., the metal composition decreased to 0.08% as illustrated in FIG. 8. Similarly, FIG. 11 depicts SEM images of a catalyst surface (a) before and (b) after purification treatment. The fibers, FIG. 11a, were treated under a hydrogen-argon atmosphere (ratio 1:20) for 24 hours at 1096° C. Treating the fibers results in the removal of the metal droplets from all observed fibers FIG. 11b.

The metal catalyst is not consumed in the reaction; therefore, as the fibrous carbon materials (e.g., carbon fibers) accumulate, the metal droplets on the fibrous carbon materials (e.g., fibers) may be separated from the fibrous carbon materials (e.g., fibers) for reuse. The detachment of metal droplets from the fibrous carbon materials (e.g., fibers) may be performed external to the reactor using methods such as heating, acid treatment, contacting the fibrous carbon materials (e.g., fibers) with a halogen gas to form a metal salt, and/or other suitable techniques. Alternatively, in some embodiments, the removal of metal droplets from the fibrous carbon materials (e.g., fibers) may take place within the reactor itself. In some embodiments, upon the completion of the catalytic process, the flow of gaseous hydrocarbon (e.g., methane) over the fibrous carbon materials (e.g., fibers) may be halted. The temperature may then be elevated. An inert gas may be passed over the metal droplet-laden fibrous carbon materials (e.g., fibers) to vaporize the metal content, and the resulting effluent may be collected downstream. Subsequently, the fibrous carbon materials (e.g., fibers) may be extracted, and the catalyst may be reloaded as needed.

Indium-containing catalyst droplets may be effectively removed from carbon-based materials through evaporation. This successful removal may be attributed to the volatile nature of indium, which readily allows for its evaporation. This evaporation-based method may be applicable to a wide range of carbon-based materials, including, but not limited to, carbon fibers, carbon mats, graphene, and graphite.

In some embodiments, evaporation is performed at temperatures greater than the temperature maintained within the vessel during the pyrolysis for producing the fibrous carbon materials (e.g., fibers). In some embodiments, evaporation is performed at temperatures above 900° C., and in some embodiments, between 100° and 1200° C., and in some embodiments at about 1100° C. For example, following the formation of fibrous carbon materials (e.g., fibers) from methane pyrolysis catalyzed by an indium-copper alloy with a 40:60 ratio, the indium-copper alloy droplets adhering to the fibrous carbon materials (e.g., fibers) may be removed through evaporation. This may be achieved by subjecting the fibrous carbon materials (e.g., fibers) to heating at temperatures within the range of from 1080 to 1090° C. within a vessel while maintaining an inert or reducing gas atmosphere. The vessel may either be the same reaction vessel where the indium-copper alloy catalyzed the pyrolysis reaction or a separate external vessel. The inert or reducing gas may be caused to flow over the fibrous carbon materials (e.g., fibers). The resulting metal-containing vapor may then be collected and condensed to regenerate the indium-copper alloy.

In some embodiments, an indium-containing metal catalyst may be used in the pyrolysis of hydrocarbon to selectively produce high-value forms of carbon such as carbon nanotubes (CNT), and in some embodiments, multi-walled carbon nanotubes (MWCNT). A carbon nanotube is a tubular structure having a diameter in the nanometer range which comprises a single or multi-walled-ring. A multi-walled carbon nanotube (MWCNT) is a tubular structure which comprises a multi-walled ring.

In some embodiments, an indium-containing metal catalyst which is used to selectively produce such high-value forms of carbon comprises an alloy. The alloy may be synthesized by combining indium and a second metal. In some embodiments, the second metal comprises one or more transition metals. In some embodiments, the second metal is selected from one or more of copper (Cu), zinc (Zn), gold (Au), tin (Sn), platinum (Pt), palladium (Pd), nickel (Ni), iron (Fe), manganese (Mn), molybdenum (Mo), and bismuth (Bi).

In some embodiments, the indium-containing metal catalyst comprises an indium content in the range of from about 30 mol. % to about 95 mol %, and in some embodiments, in the range of from about 50 mol. % to about 95 mol %, and in some embodiments, in the range of from about 70 mol. % to about 95 mol %. In some embodiments, the ratio of indium and the second metal is in the range of from about 20:80 mol % to about 95:5 mol %.

In some example embodiments, the second metal comprises copper. The indium-containing metal catalyst comprises about 50 mol. % to about 70 mol. % copper, and about 30 mol. % to about 50 mol. % indium.

### EXAMPLES

A summary of the experiments that have been done under different conditions to support parts of a mechanism is provided as follows. The following Examples are intended to be exemplary only and that numerous changes, modifications, and alterations can be employed without departing from the scope of the presently disclosed subject matter.

### Example 1

In this example, methane selected as the gaseous hydrocarbon was passed over the surface of the molten catalyst in a horizontal tube furnace. The catalyst was synthesized by mixing the two components in the desired composition, pre-melting at 980° C. in a reducing atmosphere, and then placing in the horizontal furnace. The catalyst was then reduced fully at 980° C. before methane and inert gas were passed over the catalyst surface. After about 40 minutes of reaction, the catalyst was cooled. A schematic is shown in FIG. 1. In addition, FIG. 5 is an SEM image of the fibers obtained.

### Example 2

A bubble column reactor made of quartz was filled with 60:40 Cu:In alloy as depicted in FIG. 3. A small quartz tube was immersed in the alloy when heated to 1000° C. and methane was introduced, resulting in gas bubbles that rose through the molten column. The resulting product gases, along with unreacted methane, exited the top of the column and carbon that formed floated to the surface of the melt. After 30 hours of operation, the reactor was cooled and the carbon was poured of the frozen surface. Subsequently, the fibers were removed from the metal surface and then heated to 1090° C. in a reducing atmosphere for 3 hours. FIG. 8 depicts the fibers after thermal treatment which exhibited a purity of above 99.5% as determined by EDX.

### Example 3

Methane pyrolysis was coupled with dry reforming of methane using molten metal catalysts to produce a hydrogen-rich syngas. The bubble column reactor was constructed similarly to Example 2, consisting of a quartz reactor tube filled with molten metal. In this experiment, molten Cu—In was employed as the catalyst. The reactant gas mixture, comprised of 3 sccm of Ar, 2 sccm of CH₄, and 1 sccm of CO₂, was delivered to the inner tube of the bubble column reactor. As the gas mixture exited the inner tube, it immediately made contact with the melt and ascended along the bubble column reactor. The resulting product gases, along with any unreacted gases, exited through the outer tube for analysis. Carbon fibers that were produced floated to the surface of the melt where they were later removed after cooling.

### Example 4

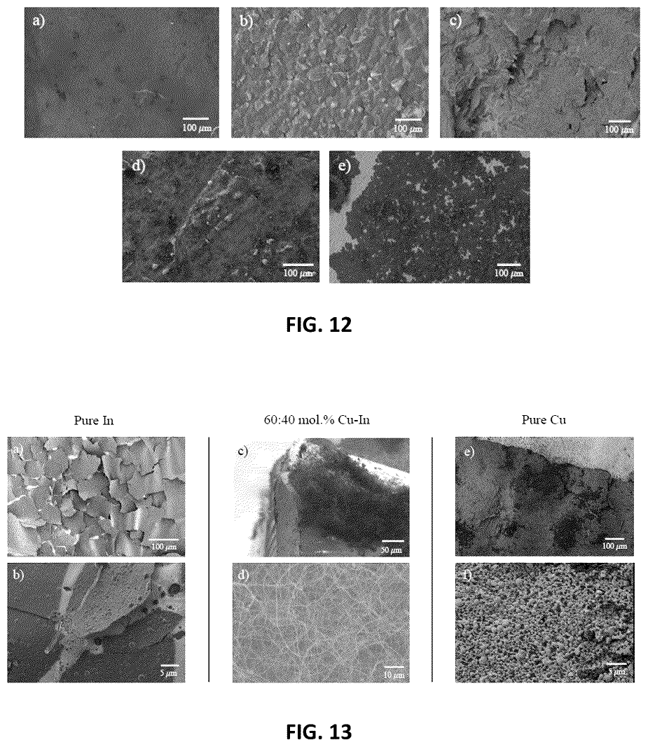

In this example, an initial catalyst screening to investigate CNF production capacity was performed. Referring to FIG. 12. the SEM images in FIG. 12. depict carbon structures on different alloy surfaces after running methane pyrolysis in a surface reactor for 40 min: a) 50:50 mol. % Ge:In. b) 50:50 mol. % Sn:In. c) 50:50 mol. % Ag:In. d) 50:50 mol. % Ge:Cu. e) 50:50 mol. % Bi:Cu. The Cu and In-based alloys—In—Sn, In—Ge, In—Ag, Cu—Ge, and Cu—Bi—each result in graphitic carbon black without any fibers. In contrast, FIG. 13. shows SEM images of carbon on various catalyst surfaces after methane pyrolysis in a surface reactor: a) and b) show pure liquid In; c) and d) show liquid 60:40 mol. % Cu—In; e) and f) show pure solid Cu. The catalysts were tested after cooling to room temperature. The Cu—In combination uniquely produces CNFs on the catalyst surface, as illustrated in FIG. 13c. and FIG. 13d. In contrast, FIGS. 13a., 13b., 13e., and 13f. demonstrate that pure In results in minimal fiber growth, whereas pure Cu does not produce fibers, remaining solid under reaction conditions due to its high melting point. These findings indicate that fiber formation is specific to the alloyed state of Cu and In.

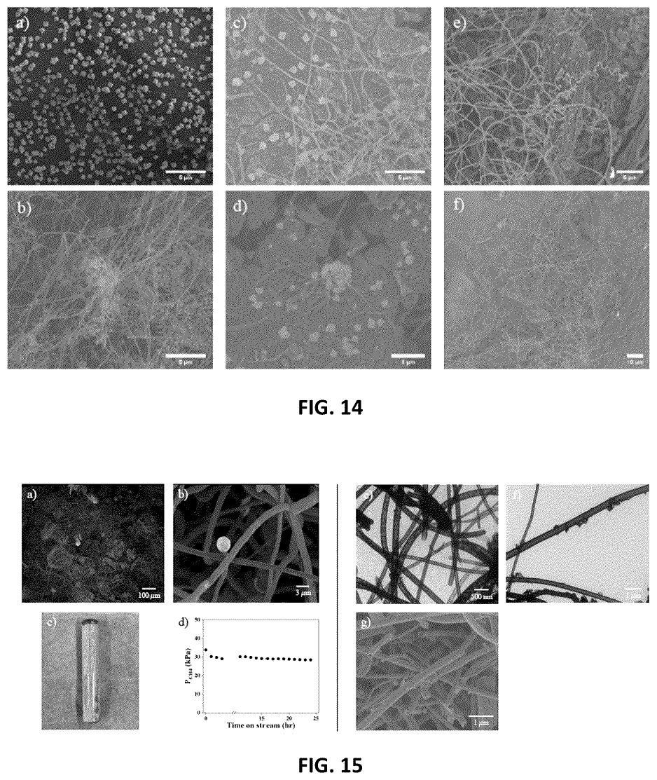

Further exploration of various Cu—In catalyst compositions, depicted in FIG. 14. a) and b) 20:80 mol. % Cu:In, c) and d) 40:60 mol. % Cu:In, e) and f) 80:20 mol. % Cu:In, reveal that a higher Cu content, specifically a molar ratio of 60:40 mol. % Cu—In, FIGS. 14c. and 14d., are optimal for producing the highest density of fibers. In contrast, referencing FIGS. 14e. and 14f, an 80:20 mol. % Cu—In ratio results in visibly fewer fibers, likely due to lower catalyst activity.

### Example 5

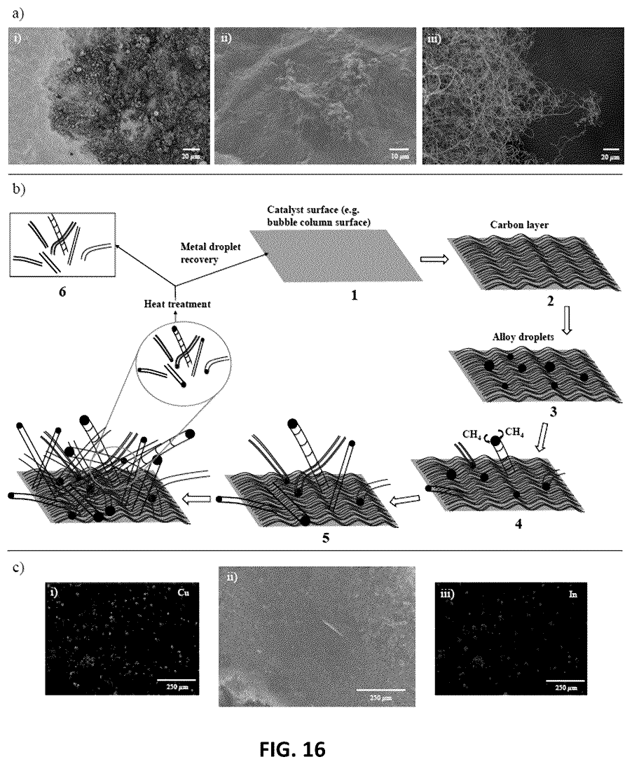

In this example, the results of a bubble column reactor methane pyrolysis experiment are described. Experiments in a bubble column reactor produced a significant quantity of CNFs. Referring to FIGS. 15a. and 15b., SEM images of CNFs generated on a 40:60 mol. % Cu:In catalyst, in a bubble column reactor (before purification) are depicted. Compared to a surface reactor, a bubble column reactor yields a greater quantity of CNFs, attributed to extended reaction times and reduced catalyst deactivation. Metal particles were found attached to the carbon, likely resulting from the turbulent surface caused by bubbling or splashing of molten metal onto the carbon when bubbles burst. The bubble column reactor also produced a greater quantity of other carbonaceous structures, such as carbon sheets and amorphous carbon. This could be due to the headspace in the bubble column reactor allowing metal vapor catalysis during pyrolysis, leading to the formation of diverse carbon structures. Additionally, gas-phase methane pyrolysis may occur, depositing different carbon structures on the reactor walls. These structures could then detach and mix with the CNFs floating on the surface. The fibers produced in the bubble column reactor setups varied in diameter from 0.1-1 μm and had estimated lengths ranging from 20 to 200 μm.

Referencing FIG. 15c., an image of the Cu—In catalyst from a bubble column reactor experiment after cooling is depicted, with carbon visible only on the top surface of the melt. This demonstrates that the bubble column reactor is the most effective setup, as it prevents catalyst deactivation by allowing carbon structures to float on the molten surface. The partial pressure of methane in the bubble column, as depicted in FIG. 15d., indicates stable catalyst performance over a 24-hour period. CH₄ conversion remained consistent within a range of 11-16%, showing a slight increase attributed to carbon buildup which extended the residence time. The rates of carbon and hydrogen production were measured at 0.8 mmol/hr and 1.6 mmol/hr, respectively. The internal structures of the CNFs after purification were investigated using electron microscopy, revealing a tubular structure. Some displayed smooth walls, while others had sectional internal walls, characteristic of bamboo-like CNFs.

Referencing FIGS. 15e. and 15f., TEM was used to probe the internal structure, illustrating both the smooth and bamboo-like forms of CNFs with a diameter of 100-200 nm. FIG. 15g. and FIG. 6. SEM depicts the smooth tubular structures of the CNFs. The presence of small amounts of non-CNF carbon products on the outer walls of some CNFs is likely due to gas-phase methane pyrolysis.

### Example 6

In this example, the initial growth behavior of the CNFs during methane pyrolysis in a bubble column reactor was examined at different reaction times. Depicted in FIG. 16a., are SEM images of a 40:60 mol. % Cu:In catalyst surface after pyrolysis for i) 2 minutes, ii) 3 minutes, and iii) 270 minutes. After only 2 minutes of reaction time, no fibers are visible on the surface of the catalyst; the carbon deposition appears amorphous or graphitic and does not yet cover the entire catalyst surface. After 3 minutes, a very small number of fibers are observed to be in clusters around a layer of deposited carbon. These fibers then become the predominant form of carbon, visible up to 270 minutes in the surface reactor, where they accumulate in large bundles on the catalyst surface. Extended reaction times result in thicker and longer fibers. Short reaction times yield fiber growth with lengths and diameters ranging between 10-100 μm and 0.1-0.3 μm. Conversely, at extended reaction times, fiber lengths range from 20-200 μm with diameters between 0.5-1 μm.

### Example 7

In this example, a droplet-based mechanism is proposed for a Cu—In catalyst system and a schematic is presented. Referencing FIG. 16b., the pathway begins with a fresh catalyst surface (step 1). Over time, a non-fibrous carbon layer forms, separating the bulk catalyst from the formed CNFs (step 2). This carbon layer acts as a barrier, enabling the formation of distinct catalyst droplets which then catalyze the formation of CNFs via both tip growth and base-growth mode (step 3 and 4). The smooth and bamboo-like structures of the CNFs continue to develop based on this mechanism as the reaction progresses (step 5). The bamboo-like structure of the CNFs is likely due to the growth of the inner wall, facilitated by the diffusion of carbon along the graphene-metal interface. Step 6 illustrates the purification process, which removes the droplets. The regeneration of the catalyst is further detailed above.

### Example 8

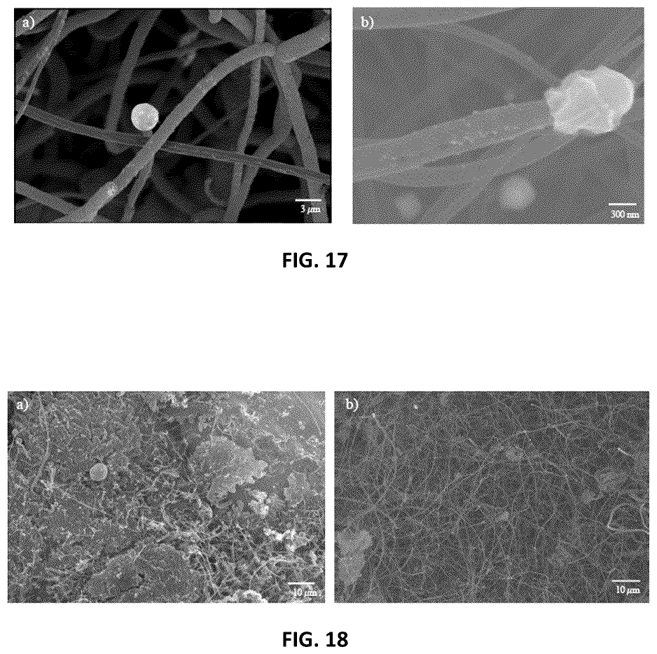

In this example, the composition of catalyst particles observed at the tips of some carbon fibers, with similar reaction conditions to Example 6, is determined. FIG. 16c depicts the EDX results of the carbon fibers after reaction. In FIG. 16c-ii, the contributions of carbon, In, and Cu are overlaid and represented in red, blue, and green respectively. Catalyst particles, varying in size but uniformly composed of Cu and In, are dispersed across the CNF sample. The location of Cu particles and In particles, shown in FIGS. 16c-i and 16c-iii, are nearly identical. These EDX images highlight the abundant presence and specific composition of the droplets associated with the synthesized CNFs, often located on the tips. Referencing FIG. 17., SEM images of a carbon fiber attached to a droplet depict that the droplet size can be a) larger than fiber diameter and b) like fiber diameter. The difference in fiber diameter and droplet diameter is likely caused by deformation of the droplet, resulting in a smaller fiber diameter compared to the droplet. In one embodiment, the droplet diameter influences the quality of the CNFs.

### Example 9

In this example, the growth behavior of CNFs on 40:60 mol. % Cu:In catalyst during methane pyrolysis was compared after a 40-minute reaction in a bubble column, both in the presence and absence of CO₂. Referring to FIGS. 18a. and 18b., the CNFs appear similar under both conditions, regardless of CO₂ presence in the feedstock.

### Example 10

In this example, the influence of catalyst composition on the growth of MWCNTs were investigated.

### Composition Series

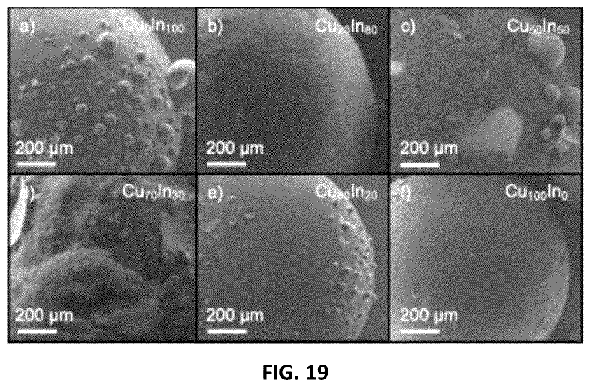

The catalysts ranged between pure Cu and pure In in intervals of 10 at. %. The catalyst loading used in these experiments is held constant at 0.75 mol/m² on non-porous quartz spheres. FIG. 19 are SEM images of the composition series, i.e., a) Cu₀In₁₀₀, b) Cu₂₀In₈₀, c) Cu₅₀In₅₀, d) Cu₇₀In₃₀, e) Cu₈₀In₂₀, f) Cu₁₀₀In₀ post-reaction. The reaction time was 2 hours for all catalysts, following the procedure provided in the Methods and Materials section

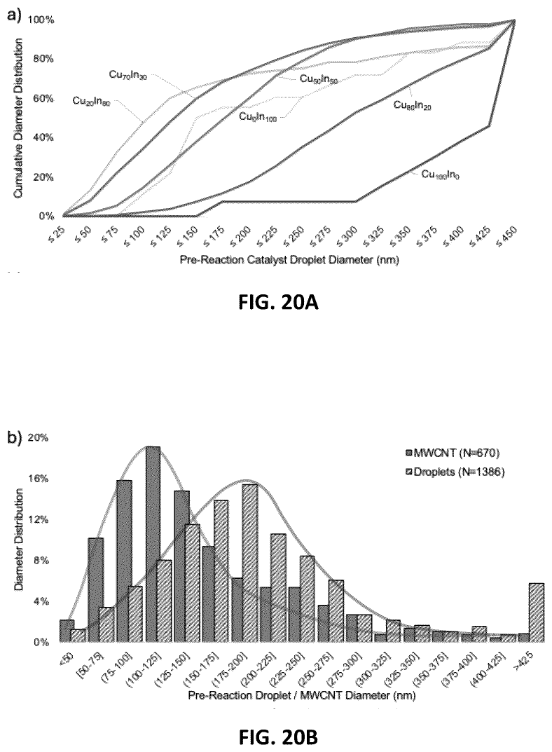

No MWCNTs were observed with pure Cu or In. Amongst all compositions tested, the largest bundles of MWCNTs were observed in the range of 50-70% Cu. The selectivity of MWCNT bundles as observed via SEM images increases with Cu content up to 70 at. % Cu. Electron microscopy is conducted at room temperature in which the catalyst droplets are frozen, however, some degree of sample heating is expected. Since the lowest melting material used in experiments melts at >150° C. and the particles are attached to heat conductive substrates, melting is not expected under imaging conditions. The alloy composition influences the size of the frozen catalyst droplet particles as shown in FIG. 20A where the post-reduction particle size distribution is given. Both pure Cu and pure In tend to yield larger particles than the alloy. Pure In had few nanoparticles below 90 nm, Cu₈₀In₂₀ had few below 80 nm, and pure Cu had none below 150 nm while the alloy between 20-70% Cu content had the smallest nanoparticles. The post-reaction particles observed in FIG. 19 are on the order of microns, the smaller nanoparticles are not visible at this magnification. The smallest particles were found on Cu₂₀In₈₀ while Cu₇₀In₃₀ had the second smallest particles. Droplet size does not appear to be the only factor influencing the selectivity to MWCNTs as Cu₇₀In₃₀ catalyst had the largest quantity of bundles of MWCNTs and Cu₂₀In₈₀ had only a moderate coverage of MWCNT over the surface. In addition, pure Cu and In generated many particles in the 100-400 nm size range as seen in FIG. 20A but did not produce MWCNTs as shown in the SEM images. FIG. 19 a) and f).

Referring to FIG. 20B. as the surface composition of In becomes >95% at 70% Cu in the bulk alloy, the lower surface tension of the droplets reduces the thermodynamic driving force for coalescence. This stabilization effect results in smaller and well dispersed droplets which are more favourable for MWCNT growth, consistent with experimental results as seen in FIG. 20A. The lowered surface tension can help explain the high selectivity of MWCNTs in the 50-70% Cu range and why the alloy performs better in producing smaller droplets than alloys with Cu content above 70%.

### Internal Structures of MWCNTs

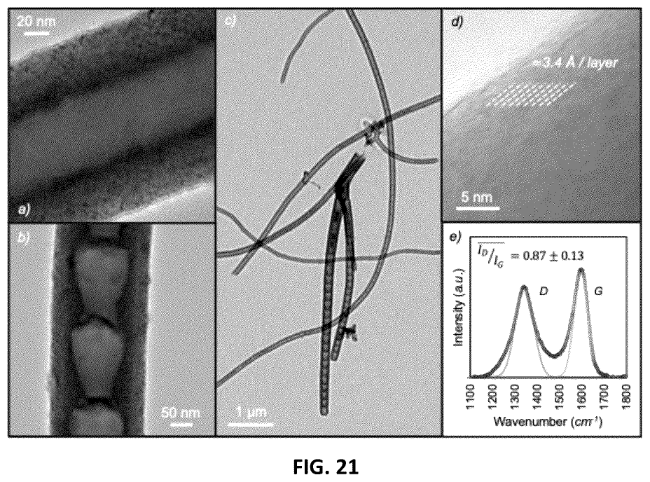

TEM was used to probe the internal structures, including smooth and bamboo-like MWCNTs as seen in FIGS. 21 a) and 21 b) respectively. FIG. 21 c) provides an overview of the MWCNTs found from the Cu—In packed bed reactor system. The sample shown in FIG. 21 is recovered from a 0.75 mol/m² (7.5 wt. %) Cu₆₀In₄₀ catalyst. TEM allows for measurement of the interlayer spacing, giving a similar interlayer spacing of 3.35±0.08 Å for a sample of the tubular carbon generated with the Cu—In catalyst, providing evidence they are MWCNTs. The graphene walls are not perfectly straight, indicating a less crystalline structure with some defects. A sample of the image is shown in FIG. 21 d). Raman spectroscopy data is given in FIG. 21 e). The D-band near 1350 cm⁻¹ corresponds to disorder and defects in the carbon nanotube structure and the G-band near 1580 cm⁻¹ corresponds to vibrational modes of sp²-bonded carbon atoms. The mean I_{D}/I_{G} ratio with 95% confidence of the MWCNTs generated in the Cu—In packed bed reactor configuration was found to be 0.87±0.13, lower than commercially available untreated Nanocyl® NC7000 MWCNTs. Further heat treatment at elevated temperatures can smooth out defects in the carbon walls, corresponding to a decrease in the I_{D}/I_{G} ratio.

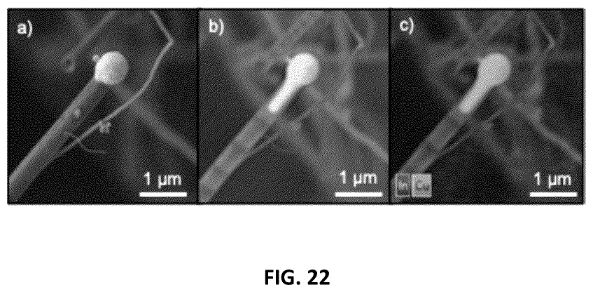

The difference between the two structures, smooth and bamboo-like MWCNTs, suggests separate mechanisms of growth for each tube morphology. In the case of the bamboo MWCNTs in FIG. 21 b), a closer look at the internal MWCNT structure can be partially unveiled using a SEM at an electron beam voltage high enough for electron penetration to occur. In FIG. 22 a), the electron beam was set to 2 kV while in b), the beam was increased to 10 kV. FIG. 22 c) shows the EDX map overlayed on the 10 kV image with In shown in purple and Cu in orange. The In and Cu signals overlap exactly indicating a homogeneous alloyed droplet.

### Droplet Growth Mechanism

The catalyst droplet, located at the tip of the MWCNT, has distinct ‘head’ and ‘tail’ sections, the tail is encased inside the MWCNT. The catalyst tail fills the bamboo-like section of the MWCNT. Carbon may be supplied via gas phase vapour deposition onto the catalyst head and carbon adatoms migrate towards the tail, extending the MWCNT structure. The bamboo-like MWCNT synthesis may occur in batches, generating one bamboo section at a time and the catalyst droplet moves along with the MWCNT growth. The sample shown in FIG. 22 is imaged directly on the catalyst support of a 0.75 mol/m² (7.5 wt. %) Cu₆₀In₄₀ catalyst. The lower melting point of Cu may allow for deformation and the tail may serve as a template for the bamboo-shaped layers of graphite.

Cu—In may be different from typical CNT growth catalysts, because of its carbon solubility. Molten Cu—In may exhibit a low solubility of carbon.

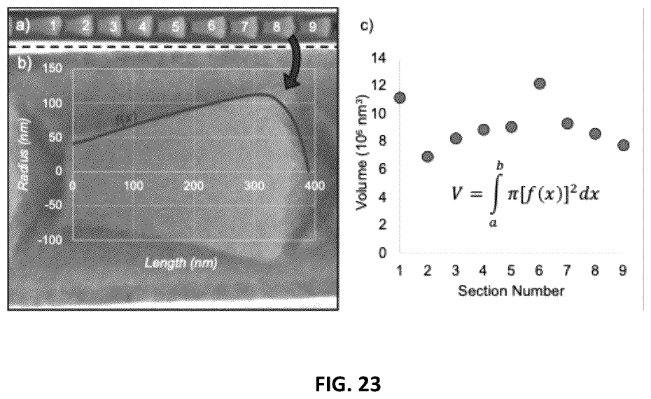

Due to the fact that molten catalysts deform under very little applied force, the growth process is likely dynamic, as supported by the inconsistent size of the void volume left behind during growth. An equation is fit to the TEM images and assuming axial symmetry, the volume of revolution can be computed to find the volume of the tail. FIG. 23 summarizes these results, showing no trends in the volume of the tail section. Instead, it varied significantly during growth. Image analysis suggests the catalyst tail tends to contain between 20-30% of the total volume of the droplet with the head containing the remainder.

The geometry of the head and tail catalyst sections may also dictate the diameter of the resultant MWCNT, yielding a diameter between that of the catalyst head and tail. A diameter size reduction is observed when comparing pre-reaction catalyst droplets and generated MWCNTs diameters, possibly largely due to the volume separation into the head and tail. For instance, a pre-reaction droplet of diameter 250 nm has a head diameter of 227 nm given the head makes up 75% of the total droplet volume. The expected diameter of the resultant MWCNT is between 200-225 nm. FIG. 20 b) plots the diameter distribution of the MWCNTs and pre-reaction catalyst droplets, quantifying the size reduction effect. The sample that was used for the frozen droplet diameter distribution is from the post-reduction 0.75 mol/m² (7.5 wt. %) Cu₆₀In₄₀ from the composition series, while the data for the MWCNTs is the compilation of measured diameters from the loading series. The preparation method inherently yields a wide droplet size distribution and the MWCNTs are shown to be able to be grown from a wide variety of droplet diameters.

### Time Series

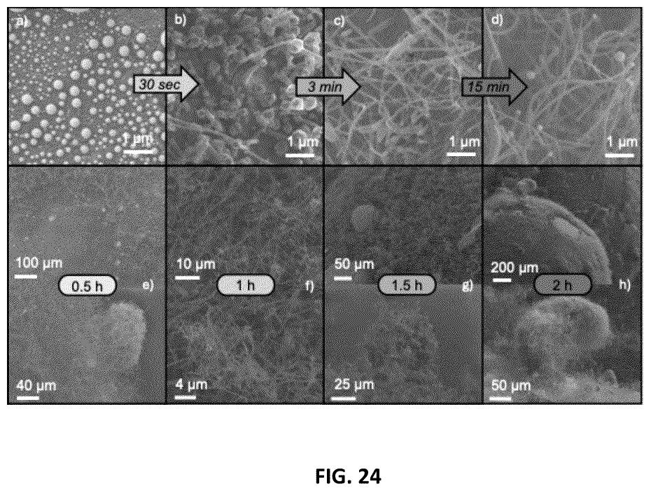

The reduced catalyst shows molten alloy droplets spread across a quartz support and are spherical in form as shown in FIG. 24 a). Following 30 seconds reaction time, early stages of tubular carbon structures begin to emerge. In FIG. 24 b), the base of the carbon structures is visibly wider and becomes thinner as the MWCNT grows further from the surface. The catalyst droplets are observed to elongate perpendicular to the catalyst support surface and move along the tip of the carbon tube once the structure grows sufficiently long. After 3 minutes, longer MWCNTs with a variety of diameters appear over the catalyst surface. Close to the surface, thick carbon structures (I˜1 μm, d˜0.5 μm) with catalyst droplets trapped inside are found, as shown by the red arrow in FIG. 24 c). After 15 minutes of reaction time, a large amount of MWCNT is observed in FIG. 24 d). The long MWCNTs are often found with catalyst droplets at the tips and have diameters ranging between 50 nm to hundreds of nanometers. Longer reaction times extending from 0.5 h to 2 h give bundles of MWCNTs as seen in FIG. 24 e)-h). After over 1 h reaction time, some MWCNTs are observed to have lengths surpassing a millimetre.

### Catalyst Composition Analysis

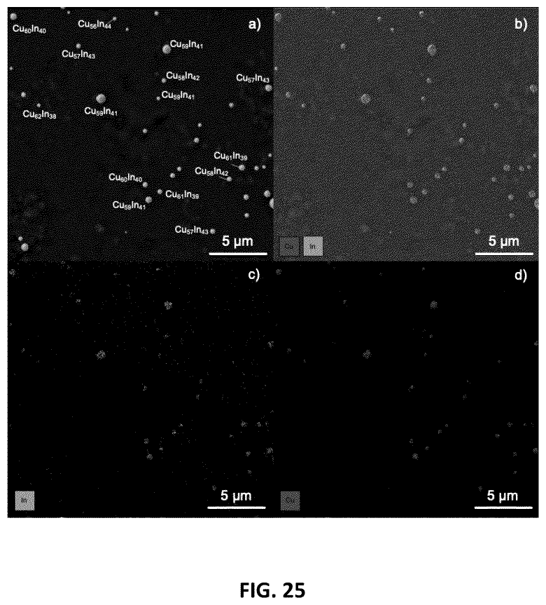

The homogeneity of the prepared alloy catalyst was analyzed using EDX as shown in the FIG. 25 images. Blank SiO₂ beads were coated with carbon by pyrolysis of methane at 1000° C. for 2 h prior to undergoing the catalyst preparation procedure to build a thick carbon layer to avoid electron scattering during imaging. After depositing catalyst precursors for a Cu₆₀In₄₀ catalyst, the sample underwent the reduction procedure and was subsequently cooled to mimic the state of the catalyst prior to the introduction of methane. FIG. 25 a) shows the SEM image of the prepared catalyst along with particle specific compositions found via EDX. The composition varied from Cu₅₆In₄₄ to Cu₆₂In₃₈ across 15 particles with the mean composition being Cu₅₉In₄₁. The strong co-localization of the Cu and In EDX scans are demonstrated in FIG. 25 b) where the red Cu signal and cyan In signal are overlapped.

The bulk composition of the catalyst alloy is measured via ICP-MS on a Cu₆₀In₄₀ catalyst post-pyrolysis. ICP-MS was run in triplicates on the same sample after undergoing the catalyst removal procedure. The bulk composition of the metal residue is found to be 60.2±3.0 at. % Cu to 39.8±3.0 at. % In, closely matching the intended composition. Table 1 summarizes the ICP-MS results for the metal remaining in the MWCNT samples.

TABLE 1
Ratio of remaining Cu at. % and In at. % attached to the
MWCNTs after carbon removal measured using ICP-MS.

| MWCNT Sample | Cu at. % | In at. % |
|---|---|---|
| 1 | 60.61 | 39.39 |
| 2 | 58.89 | 41.11 |
| 3 | 61.12 | 38.82 |

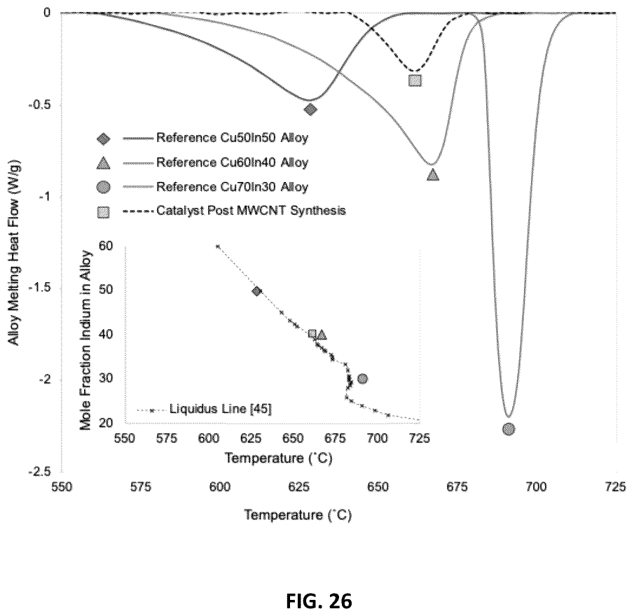

Alloy homogeneity was also assessed using thermal analysis, analyzing the breadth and location of melting peaks. FIG. 26 plots the melting heat flux per mass sample as a function of temperature, showing the endothermic melting heat flux for the recovered MWCNT sample with residual metal compared to reference alloys. Both MWCNT samples generated from the prepared Cu₆₀In₄₀ catalyst show a narrow peak breadth and align very well with the reference Cu₆₀In₄₀ alloy. A broad peak would be expected if a variety of alloy compositions were present in the sample, each with different DTA melting signatures. For the 40-50% In range, the solid-liquid gap is very wide as demonstrated by the phase diagram, resulting in continuous melting across a wider range of temperature and broader peaks than the 30% In alloy. The insert in FIG. 26 shows the alloy liquidus line compared to the temperature of maximum heat flow, showcasing close match between expected values and measured values via DTA. The results from EDX, ICP-MS, and DTA support homogenous alloys being generated through this preparation method, shown by both the strong co-localization of each Cu and In in the alloy particles via EDX along with the bulk composition verification.

### Loading Series

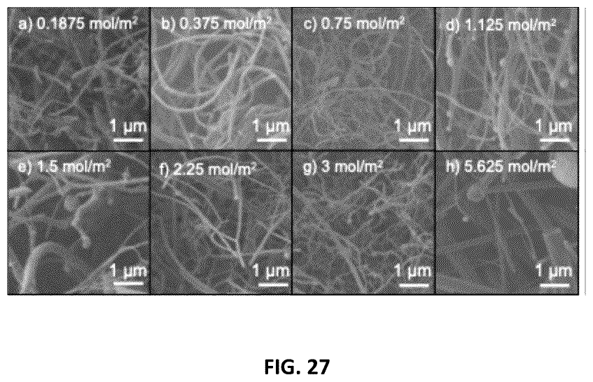

The impact of catalyst loading was investigated by varying the amount salt precursor added to the catalyst preparation step. The catalyst supports are non-porous quartz spheres with an average diameter of 1.91 mm. The loading listed in mol/m² can be converted to a weight percent (wt. %) using the support surface area, the molar mass of the alloy, and the density of quartz. The loadings used in these experiments converted into wt. %, range from 2.0 wt. % to 37.9 wt. %. SEM images of the synthesized MWCNTs for the different catalyst loadings are shown in FIG. 27, specifically, a) 0.1875 mol/m² (2.0 wt. %), b) 0.375 mol/m² (3.9 wt. %), c) 0.75 mol/m² (7.5 wt. %), d) 1.125 mol/m² (10.9 wt. %), e) 1.5 mol/m² (14.0 wt. %), f) 2.25 mol/m² (19.6 wt. %), g) 3 mol/m² (24.6 wt. %), h) 5.625 mol/m² (37.9 wt. %). No noticeable trends were observed visually via SEM in terms of MWCNT coverage, diameter, and length of MWCNTs after 15 minutes of reaction time. Since the datasets show no trends, an overall MWCNT diameter distribution can be generated by combining these datasets, as plotted in FIG. 20 b). With excess catalyst metal at high loadings, very large catalyst droplets with diameters larger than a micron form and do not participate in generating MWCNTs. However, plenty of small droplets remain which is why the resultant MWCNTs are independent of loading. All other experiments were conducted using the 0.75 mol/m² (7.5 wt. %) loading as higher loadings offered no benefit and lower loadings yielded slightly lower coverage of MWCNTs. The overall mean MWCNT diameter was found to be 151 nm and a median of 128 nm.

### Carbon as a Catalyst Support

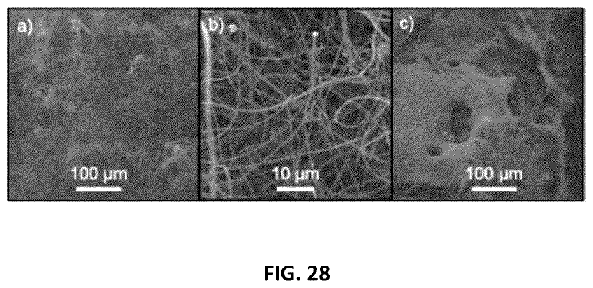

The experiments of the results shown in FIGS. 19-27 were conducted using quartz supports. FIG. 28 are SEM images of MWCNTs generated from Cu—In droplets on a carbon support. No noticeable differences were observed in the images and similar MWCNTs were observed when using carbon as a substrate rather than quartz, indicating the quartz interaction with the molten Cu—In droplets is not critical for the growth.

### Methods and Materials

Catalyst Preparation: High purity (>99%) copper and indium nitrates purchased from Sigma-Aldrich were used as the catalyst precursors for packed bed reactor experiments. Aqueous stock solutions of 0.2 mmolₘₑₜₐₗ gₛₒₗᵤₜᵢₒₙ⁻¹ were prepared and placed in a rotary evaporator to deposit nitrates onto catalyst supports, either quartz or carbon. Non-porous supports were preferred as a porous support would obscure the intended simulation of the behaviour of droplets which are generated in-situ in other reactor configurations. The supports with deposited nitrates were heated in air at 500° C. for 30 minutes until the nitrates were completely decomposed, leaving behind the metal oxides.

Reduction and Pyrolysis: The oxidized catalyst was placed into a vertical 10 mm I.D. quartz tube with coarse quartz wool (diameter 9-30 μm) or a porous quartz frit supporting the catalyst bed. Ar and H₂ at 3 and 7 SCCM, respectively, were introduced into the bottom of the reactor and the reactor was then heated from room temperature to the target temperature of 1000° C. at a ramp rate of 20° C. min⁻¹, to reduce the precursor oxides. A Lindberg/Blue M Mini-Mite Tube Furnace was used for heating. H₂ is turned off for 15 minutes prior to starting CH₄ flow to remove residual H₂ from the reduction step. CH₄ is added at 7 SCCM over the desired reaction time. After the desired reaction time, CH₄ flow and the tube furnace are turned off.

Time Series Experiments: The reduction and pyrolysis procedure are kept identical to all other experiments apart from short reaction times. Reaction times of 30 seconds, 3 minutes, and 15 minutes were investigated to reveal the early reaction time behaviour of the catalyst droplets. After turning off CH₄ at the end of the early time series experiments of ≤15 minutes, the flow of Ar was increased to 15 SCCM during cooling to quickly purge residual CH₄.

Carbon Removal Procedure: For transmission electron microscopy (TEM), differential thermal analysis (DTA), and inductively coupled plasma mass spectrometry (ICP-MS), the carbon product was removed from the support. Due to the size and non-porous nature of the support, removal of the product can be done via agitation in a solvent. Spent catalyst beads were added to a sample vial with enough ethanol to fully submerge the sample. The sample is shaken lightly by hand, removing the majority of the loose MWCNTs.

Catalyst and MWCNT Characterization: To determine the diameters of droplets and MWCNTs, a Zeiss XB350 crossbeam scanning electron microscope (SEM) was used. SEM images were also used to identify the catalyst selectivity to MWCNTs, the size and quantity of MWCNT bundles gives a relative selectivity. Connected to the SEM is an energy-dispersive X-ray spectroscopy (EDX) detector used to determine the atomic composition of samples. Catalyst beads were directly imaged under SEM by using a carbon adhesive on a sample stand. TEM images were taken with a Tecnai Spirit TEM at 120 kV for investigation of the internal structures of the MWCNTs. The solution with suspended MWCNTs is diluted with more ethanol and pipetted onto a copper TEM grid. Since the volume of pipetted solution is only a few microliters, the solution is shaken briefly prior to pipetting to resuspend any settled particles. Imaging was performed ex-situ at room temperature where the catalyst is completely solidified. Raman spectroscopy was conducted using a Horiba XploRA Plus μ-Raman Spectrometer with a 532-nm laser. Spectra acquisition was averaged over 3 accumulations of 60 s each with integration time of 1 s. A 100× objective lens was used for guiding the laser and the spectral resolution was ˜2 cm⁻¹.

Catalyst Composition Measurements: DTA and ICP-MS were used to determine the bulk alloy composition of the alloys. DTA was measured using a Shimadzu DTG-60 to determine melting temperatures of samples. Reference bulk alloys were prepared by combining high purity Cu (99.5%) and In (99.99%) powders from Sigma-Aldrich and were fully melted under a hydrogen atmosphere at 1000° C. until homogenized. The prepared alloys were crushed in a mortar and pestle and passed through a sieve to isolate ≤90 μm particles. The powdered alloys were placed in the DTG-60 in alumnia sample cups with a gas flow of 200 SCCM Ar. The testing procedure was a 30 minute hold at room temperature to purge residual gasses, followed by a 20° C./min ramp to 1000° C. Recovered carbon with residual metal was tested for alloy composition by undergoing the removal procedure, followed by drying the suspension into the sample cup over a hotplate. An Agilent 7850 ICP-MS was used to determine the ratio of Cu and In attached to the CNTs. Following the carbon removal procedure, the remaining ethanol was evaporated and 3 samples were prepared by wet digestion. For each sample, 10 mg of the CNTs were added to a 3 mL concentrated HNO₃ (67-70% trace metal grade purchased from Fisher Scientific) and 1 mL H₂O₂ (30% purchased from Sigma-Aldrich) solution. The CNTs were digested for 8 h at 110-120° C. using a heating mantle. The final solution was passed through a 0.22 μm filter to remove remaining solids, and then is subsequently diluted in 2% HNO₃ before analyzed by ICP-MS.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

### REFERENCES

The following documents describe related technologies. Embodiments of the present technology may incorporate features as described in these references. All of the following references are hereby incorporated herein by reference as if fully set forth herein for all purposes.
[1] World Energy Council. New Hydrogen Economy: Hope or Hype?. World Energy Council; 2019. https://www.worldenergy.org/assets/downloads/WEInsights-Brief-New-Hydrogen-economy-Hype-or-Hope-ExecSum.pdf. Accessed Aug. 11, 2023.
[2] Sánchez-Bastardo, N.; Schlögl, R.; Ruland, H. Methane Pyrolysis for CO2-Free H2 Production: A Green Process to Overcome Renewable Energies Unsteadiness. Chemie Ingenieur Technik 2020, 92 (10), 1596-1609. DOI: 10.1002/cite.202000029.
[3] Parkinson, B.; Tabatabaei, M.; Upham, D. C.; Ballinger, B.; Greig, C.; Smart, S.; McFarland, E. Hydrogen Production Using Methane: Techno-Economics of Decarbonizing Fuels and Chemicals. International Journal of Hydrogen Energy 2018, 43 (5), 2540-2555. DOI:10.1016/j.ijhydene.2017.12.081.
[4] Rahimi, N.; Kang, D.; Gelinas, J.; Menon, A.; Gordon, M. J.; Metiu, H.; McFarland, E. W. Solid Carbon Production and Recovery from High Temperature Methane Pyrolysis in Bubble Columns Containing Molten Metals and Molten Salts. Carbon 2019, 151, 181-191. DOI: 10.1016/j.carbon.2019.05.041.

1. A method of producing fibrous carbon materials, comprising:
contacting a gaseous hydrocarbon feed with a metal catalyst containing indium within a vessel to produce the fibrous carbon materials on a surface of the metal catalyst, wherein the fibrous carbon materials comprise a tubular structure with an average diameter less than an average length thereof; and
collecting the fibrous carbon materials.

2. The method as defined in claim 1, wherein depositing the metal catalyst droplets in the vessel comprises depositing the metal catalyst on an inert material.

3. The method as defined in claim 1, wherein the producing of the fibrous carbon materials comprises forming one or more fibrous carbon materials with a tubular structure.

4. The method according to claim 1, wherein the metal catalyst containing indium comprises an alloy comprising indium and one or more second metals.

5. The method according to claim 1, wherein the collecting of the fibrous carbon materials comprises removing the fibrous carbon materials from a surface of a molten media comprising the metal catalyst within the bubble column reactor.

6. The method according to claim 5, wherein the step of removing the fibrous carbon materials from the surface of the bubble column reactor comprises entraining the fibrous carbon materials in a gas stream, and the method further comprises discharging the gas stream out of the vessel.

7. The method according to claim 1, further comprising removing the metal catalyst from the plurality of carbon fibers to purify the carbon fibers, and wherein the step of removing the metal catalyst from the carbon fibers comprises supplying a gas over the fibrous carbon materials at a vaporization temperature, thereby vaporizing the metal catalyst to produce purified fibrous carbon materials and an effluent comprising the metal catalyst.

8. The method according to claim 1, wherein the fibrous carbon materials comprise carbon fibers and/or carbon nanotubes (CNT).

9. The method according to claim 4, wherein the one or more second metals comprises one or more transition metals.

10. The method according to claim 4, wherein the one or more second metals are selected from the group consisting of copper (Cu), zinc (Zn), gold (Au), tin (Sn), platinum (Pt), palladium (Pd), nickel (Ni), iron (Fe), manganese (Mn), molybdenum (Mo), and bismuth (Bi).

11. A method of producing fibrous carbon materials, comprising:
contacting a gaseous hydrocarbon feed with a metal catalyst containing indium within a vessel for a first time interval to produce a first carbon product on a surface of the metal catalyst;
continuously contacting the hydrocarbon feed with the metal catalyst for a second time interval to produce a plurality of molten metal droplets on a surface of the first carbon product; and
further continuously contacting the hydrocarbon feed with the metal catalyst for a third time interval to produce the fibrous carbon materials from the plurality of molten metal droplets.

12. The method as defined in claim 11, wherein the first carbon product comprises an amorphous carbon.

13. The method as defined in claim 11, wherein depositing the metal catalyst droplets in the vessel comprises depositing the metal catalyst on an inert material.

14. The method as defined in claim 11, wherein the producing of the fibrous carbon materials comprises forming one or more fibrous carbon materials with a tubular structure.

15. The method according to claim 11, wherein the metal catalyst containing indium comprises an alloy comprising indium and one or more second metals.

16. The method according to claim 11, wherein the collecting of the fibrous carbon materials comprises removing the fibrous carbon materials from a surface of a molten media comprising the metal catalyst within the bubble column reactor.

17. The method according to claim 16, wherein the step of removing the fibrous carbon materials from the surface of the bubble column reactor comprises entraining the fibrous carbon materials in a gas stream, and the method further comprises discharging the gas stream out of the vessel.

18. The method according to claim 11, further comprising removing the metal catalyst from the plurality of carbon fibers to purify the carbon fibers, and wherein the step of removing the metal catalyst from the carbon fibers comprises supplying a gas over the fibrous carbon materials at a vaporization temperature, thereby vaporizing the metal catalyst to produce purified fibrous carbon materials and an effluent comprising the metal catalyst.

19. The method according to claim 11, wherein the fibrous carbon materials comprise carbon fibers and/or carbon nanotubes (CNT).

20. A method of producing fibrous carbon materials, comprising:
depositing a metal catalyst containing indium in a vessel;
maintaining the vessel at a temperature to produce a plurality of molten metal droplets; and
contacting a gaseous hydrocarbon feed with the plurality of molten metal droplets for a time interval to produce the fibrous carbon materials from the plurality of molten metal droplets.
